(19) United States
(12) Patent Application Publication
(10) Pub. No.: US 2018/0229856 A1
(43) Pub. Date: Aug. 16, 2018

(54) MONITORING AIRCRAFT OPERATIONAL PARAMETERS DURING TURNAROUND OF AN AIRCRAFT

(71) Applicants: AIRBUS GROUP INDIA PRIVATE LIMITED, Bangalore (IN); AIRBUS (S.A.S.), Blagnac (FR); AIRBUS OPERATIONS (S.A.S.), Toulouse (FR)

(72) Inventor: ASHUTOSH AGRAWAL, Bangalore (IN)

(21) Appl. No.: 15/951,210

(22) Filed: Apr. 12, 2018

Related U.S. Application Data
(63) Continuation-in-part of application No. 15/206,332, filed on Jul. 11, 2016.

(30) Foreign Application Priority Data
Jul. 10, 2015 (IN) 3547/CHE/2015
Nov. 8, 2016 (IN) 201643038167

(51) Int. Cl. B64D 45/00; B64D 43/00

(52) U.S. Cl. CPC B64D 45/00; B64D 43/00

(57) ABSTRACT

In one example, a computing system to monitor aircraft operational parameters during turnaround of an aircraft is disclosed. The computing system may include at least one processor, and memory coupled to the at least one processor. The memory may include an analytics module to obtain at least one aircraft operational parameter during turnaround of an aircraft from an aircraft on-board system, analyze the at least one aircraft operational parameter related to the turnaround with respect to a threshold value or a range of threshold values, and generate an alert based on the analysis of the at least one obtained aircraft operational parameter.

### RELATED APPLICATIONS

This application is a continuation-in-part of U.S. patent application Ser. No. 15/206,332 entitled MONITORING SCHEDULED TURNAROUND ACTIVITIES AND ALERTING ON TIME DEVIATION OF SCHEDULED TURNAROUND ACTIVITIES, filed on Jul. 11, 2016, which claims the benefit under 35 U.S.C. 119(a)-(d) to Indian Application number 3547/CHE/2015 entitled MONITORING SCHEDULED TURNAROUND ACTIVITIES AND ALERTING ON TIME DEVIATION OF SCHEDULED TURNAROUND ACTIVITIES, filed on Jul. 10, 2015, and Indian Patent of Addition Application number 201643038167 entitled MONITORING AIRCRAFT OPERATIONAL PARAMETERS DURING TURNAROUND OF AN AIRCRAFT, filed on Nov. 8, 2016, by AIRBUS GROUP INDIA PRIVATE LIMITED, AIRBUS (S.A.S.) and AIRBUS OPERATIONS (S.A.S.) which is herein incorporated in its entirety by reference for all purposes.

### TECHNICAL FIELD

Embodiments of the present subject matter generally relate to turnaround activities for aircrafts, and more particularly, to monitoring aircraft operational parameters during turnaround for the aircrafts.

### BACKGROUND

Nowadays, airline operators are focusing on minimizing time taken to perform turnaround activities during entire journey of aircrafts to reduce the cost of the journey. Several complicated turnaround activities may be coordinated between airports and the airline operators during the journey of the aircrafts. Time consumed to perform the turnaround activities (e.g., scheduled turnaround activities and monitoring aircraft operational parameters) may be gathered from various sources, such as airline operators and/or ground handlers that monitor the turnaround activities from touchdown to takeoff of the aircraft. The airline operators and the ground handlers may manually record the aircraft operational parameters which may be affected by manual error which may cause incorrect recordings to perform turnaround activities.

### SUMMARY

In one aspect, a computing system may include at least one processor, and memory coupled to the at least one processor. The computing system may reside on-board of an aircraft or off-board of the aircraft. The memory may include an analytics module to obtain at least one aircraft operational parameter during turnaround of an aircraft from an aircraft on-board system, compare the at least one aircraft operational parameter related to the turnaround with a threshold value or a range of threshold values, and generate an alert when the at least one aircraft operational parameter related to the turnaround is above or below the threshold value or the range of threshold values (e.g., does not match the predefined threshold range). The computing system may include at least one user interface to present the at least one aircraft operational parameter and the generated alert.

In another aspect, at least one aircraft operational parameter is monitored by an aircraft on-board system during turnaround of an aircraft using at least one sensor disposed in the aircraft. Further, the at least one monitored aircraft operational parameter is obtained from the aircraft on-board system during the turnaround of the aircraft. Furthermore, the at least one obtained aircraft operational parameter is analyzed and an alert is generated based on the analysis of the at least one obtained aircraft operational parameter.

In yet another aspect, a non-transitory computer-readable medium having computer executable instructions stored thereon, which when executed by a processor causes the processor to perform the above described method.

The system and method disclosed herein may be implemented in any means for achieving various aspects. Other features will be apparent from the accompanying drawings and from the detailed description that follow.

### BRIEF DESCRIPTION OF THE DRAWINGS

Various embodiments are described herein with reference to the drawings, wherein:

FIG. 1 illustrates a block diagram of an example computing system for obtaining turn around activities and generating alerts based on the analysis of the obtained turnaround activities.

FIG. 2 illustrates an architecture of an example analytics module and its interaction with aircraft on-board system and ground station system to obtain and analyze aircraft operational parameters and time stamps associated with each scheduled turnaround activity;

FIG. 3 illustrates a timing diagram showing various stages during journey of an aircraft, according to one embodiment;

FIG. 4 illustrates a block diagram showing an example sequence of scheduled turnaround activities from touchdown to takeoff of the aircraft;

FIG. 5 illustrates an example flowchart of a method for generating alerts based on analysis of the monitored aircraft operational parameters;

FIG. 6 illustrates an example block diagram showing a non-transitory, computer-readable medium that stores instructions for generating alerts based on an analysis of the monitored aircraft operational parameters.

The drawings described herein are for illustration purposes only and are not intended to limit the scope of the present disclosure in any way.

### DETAILED DESCRIPTION

A system and method for monitoring aircraft operational parameters during turnaround of an aircraft and generating alerts based on aircraft operational parameters are disclosed. In the following detailed description of the embodiments of the present subject matter, references are made to the accompanying drawings that form a part hereof, and in which are shown by way of illustration specific embodiments in which the present subject matter may be practiced. These embodiments are described in sufficient detail to enable those skilled in the art to practice the present subject matter, and it is to be understood that other embodiments may be utilized and that changes may be made without departing from the scope of the present subject matter. The following detailed description is, therefore, not to be taken in a limiting sense, and the scope of the present subject matter is defined by the appended claims.

During journey of an aircraft, turnaround activities (e.g., scheduled turnaround activities and aircraft operational parameters) may be monitored from touchdown to takeoff of the aircraft. The scheduled turnaround activities, for example, may include ground handling activities and aircraft activities. Further, the ground handling activities, for example, may include refueling, cargo door open, cargo door close, toilet drain cycle, water filling, and the like. Similarly, the aircraft activities, for example, may include touchdown, braking start, brake fans start, brake fans stop, breaking release, parking brake on, engine stop, aircraft arrival, aircraft docking, aircraft pull away, takeoff braking start, reaching taxi speed, engine stops, and the like. The aircraft operational parameters, for example, may include cabin temperature, cargo temperature, flight deck temperature, wheel temperature, wheel pressure, fuel temperature, auxiliary power unit (APU) start and stop, APU bleed valve open and close, ground power unit (GPU) connection and disconnection, air conditioning unit connection and disconnection, cabin ready, evacuation slides status, landing runway, global positioning system (GPS) position, flight details, navigation database expiry and cycle, water quantity requested, water quantity filled, refueling quantity requested and refueling quantity filled, doors open and close, and ground service panels open and close.

In accordance with an example of the present disclosure, a system monitors turn around activities (e.g., aircraft operational parameters) by leveraging data collected from the aircraft or from dedicated portable electronic devices operated in and around the aircraft. The system provides support through a set of advisory messages or alarms in order to minimize schedule disruption due to unexpected events. By using the advisory messages or alarms, operating conditions (e.g., environmental conditions, aircraft status) is attained and properly shared to personnel in the aircraft and/or operational control center (OCC).

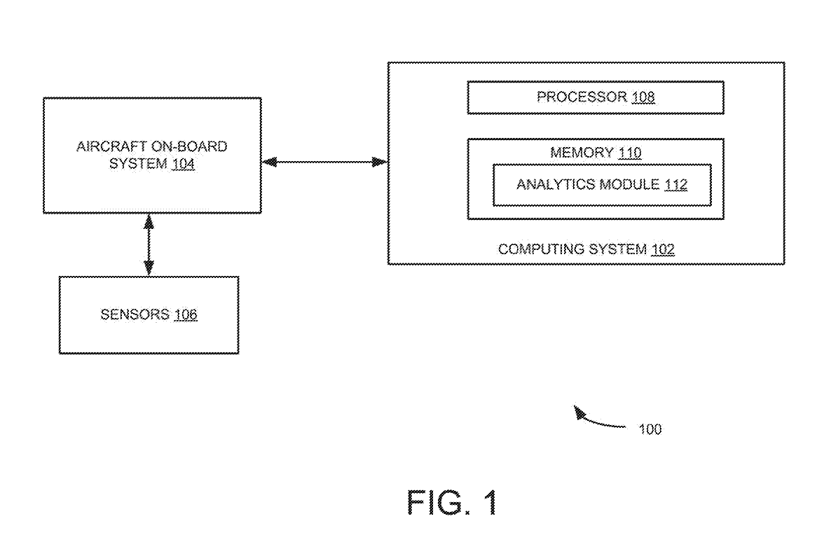

An example system and method for monitoring turnaround activities and generating alerts based on the monitored turnaround activities will now be described with reference to FIG. 1 through FIG. 6.

FIG. 1 illustrates a block diagram of an example system 100 for obtaining turn around activities and generating alerts based on the analysis of the obtained turnaround activities. In one example, the system 100 may include an aircraft on-board system 104, a computing system 102 communicatively coupled to the aircraft on-board system 104. The computing system 102 may reside on-board of an aircraft or off-board of the aircraft. The computing system 102 may include a processor 108, and memory 110 communicatively coupled to the processor 108. The memory may include an analytics module 112. For the purpose of explanation, the analytics module 112 is illustrated to be present on the computing system 102.

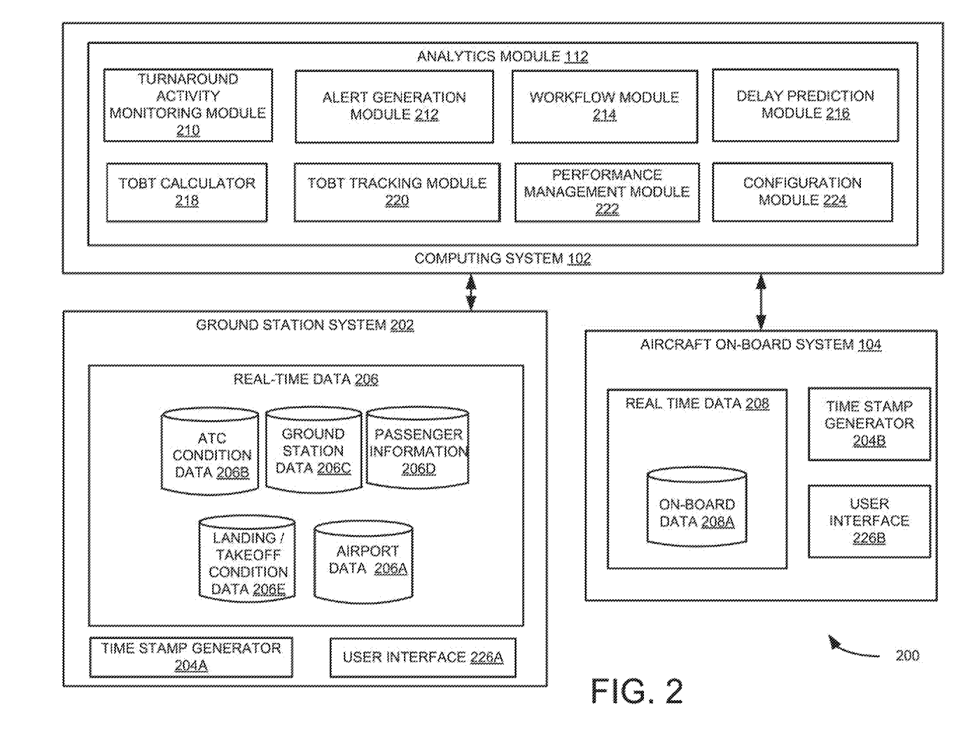

In one embodiment, the analytics module 112 may also be present within the aircraft onboard system 104 and/or a ground station system (e.g., ground station system 202 of FIG. 2). The aircraft on-board system 104 may include, for example, aircraft condition monitoring system (ACMS), cabin intercommunication data system (CIDS), cabin video monitoring system (CVMS), and the like. Similarly, the ground station system 202 may include, for example, systems at airport, ground handling units, airline computing systems and the like. Further, the aircraft onboard system 104 and the ground station system 202 may include one or more interfaces (e.g., user interfaces 226A and 226B of FIG. 2).

The aircraft onboard system 104 and the ground station system 202 may be communicatively connected to the computing system 102 via a communication network. For example, the communication network may include one of an Internet, an airport Wi-Fi, a mobile network, an in-flight Internet and the like. Further, the one or more intertfaces may include an airline enterprise interface, an airport interface, a ground handling interface, and other such interfaces.

In operation, the analytics module 112 may obtain turnaround activities from touchdown to takeoff of the aircraft and generate alerts based on the analysis of the obtained turnaround activities. For example, the turnaround activities may include scheduled turn around activities that can be performed by ground personnel during the turnaround of the aircraft and aircraft operational parameters that can be measured/recoded by ground personnel during the turnaround of the aircraft.

In one example, the analytics module 112 may automatically obtain at least one aircraft operational parameter during turnaround of an aircraft from the aircraft on-board system 104. Example aircraft operational parameter may include cabin temperature, cargo temperature, flight deck temperature, wheel temperature, wheel pressure, fuel temperature, auxiliary power unit (APU) start and stop, APU bleed valve open and close, ground power unit (GPU) connection and disconnection, air conditioning unit connection and disconnection, cabin ready, evacuation slides status, landing runway, global positioning system (GPS) position, flight details, navigation database expiry and cycle, water quantity requested, water quantity filled, refueling quantity requested and refueling quantity filled, doors open and close, and/or ground service panels open and close.

In one example, the at least one aircraft operational parameter is obtained using at least one sensor 106 installed/disposed in and around the aircraft. In this case, the aircraft on-board system 104 may receive the at least one aircraft operational parameter from at least one sensor 106 disposed in the aircraft, and then the aircraft on-board system 104 may send the at least one aircraft operational parameter to the analytics module 112 via a network. Example sensor 106 may include a video camera, an audio sensor and/or a temperature sensor.

Further, the analytics module 112 analyze the at least one aircraft operational parameter related to the turnaround with respect to a threshold value or a range of threshold values and generate an alert based on the analysis of the at least one obtained aircraft operational parameter. In one example, the analytics module 112 may compare the at least one aircraft operational parameter to determine whether the at least one aircraft operational parameter related to the turnaround is above or below the threshold value or the range of threshold values (e.g., using turnaround activity monitoring module 210 of FIG. 2). Furthermore, the analytics module 112 may generate an alert when the at least one aircraft operational parameter related to the turnaround is above or below the threshold value or the range of threshold values (e.g., using alert generation module 212 of FIG. 2). In one example, an alert may be generated and sent when any aircraft operational parameter related to turnaround crosses threshold limits. For example, an alert may be generated and sent when cabin temperature crossing threshold limits, fuel temperature crossing threshold limits, brake (wheel) temperature crossing threshold limits, and the like. In another example, alerts may be generated upon performing computation, for example, time from APU started to current time needs to be computed and then compared with the threshold.

The aircraft operational parameter and the generated alert may be presented/displayed on the user interface associated with the ground station system 202, the aircraft on-board system 104 and/or the computing system 102. The analytics module may further include a configuration module 224, as shown in FIG. 2, to configure aircraft turn around activities to be performed to monitor the at least one aircraft operational parameter based on at least one of airline operations and airport conditions.

In another example, the aircraft onboard system 104 and the ground station system 202 may receive on-board data and ground station data respectively and generate actual start and end time stamps for scheduled turnaround activities for which the on-board data and ground station data are received. Further, the aircraft onboard system 104 and the ground station system 202 may send the actual start and end time stamps for scheduled turnaround to the analytics module 112 through the communication network.

Further, the analytics module 112 may monitor time taken for each scheduled turnaround activity from touchdown to takeoff of the aircraft. In one example, the analytics module 112 may monitor time taken for each scheduled turnaround activity by obtaining the actual start and end time stamps associated with each scheduled turnaround activity from the aircraft on-board system 104 and/or the ground station system 202 (e.g., using turnaround activity monitoring module 210 of FIG. 2). Analysis of scheduled turnaround activities is explained in detail in FIG. 2.

Referring now to FIG. 2, which illustrates an example architecture 200 of an analytics module 112 and its interaction with the aircraft on-board system 104 and the ground station system 202 to obtain and analyze actual start and end time stamps associated with each scheduled turnaround activity and aircraft operational parameters. The architecture 200 may include time stamp generators 204A and 204B within the ground station system 202 and aircraft on-board system 104, respectively. The time stamp generators 204A and 204B may generate the actual start and end time stamps based on real-time data 206 and 208 associated with each scheduled turnaround activity. For example, the actual start and end time stamps may be generated based on time taken to cool the brakes. In one example, the real time data 206 and 208 may be understood as data that is produced immediately after each scheduled turnaround activities without any delay in the timeliness. In one example, the real-time data 206 and 208 may be received by the aircraft on-board system 104 and/or ground station system 202 for generating the actual start and end time stamps based on real-time data 206 and 208 associated with each scheduled turnaround activity by the time stamp generators 204A and 204B.

Further, the real time data 206, for example, may include airport data 206A, air traffic control (ATC) condition data 206B, ground station data 206C, passenger information 206D, and landing or takeoff condition data 206E. Real time data 208 may include on-board data 208A. In one example, the airport data 206A may include a terminal number, a gate number, an exit gate number and so on. Also, the on-board data 208A may include, for example, time taken for touchdown, braking start, taxi speed reached, brake fans start, brake fans stop, braking release, parking brake on, APU start/GPU connect, engine stop, skybridge/ladder connect, passenger doors open, first passenger de-boarding (obtained from cabin video feed), last passenger de-boarding (obtained from cabin video feed), cleaning finish, first passenger boarding (obtained from cabin video feed), last passenger boarding (obtained from cabin video feed), passenger door closed, forward cargo door open, rear end cargo door open, forward cargo door close, rear end cargo door close, refueling start, refueling stop, catering door open, catering door closed, portable water filling start, portable water filling stop, toilet drain cycle start, toilet drain cycle stop, maintenance activity start, maintenance activity stop, parking brake release, engine start, APU/GPU stop, pushback start, brake fans start, brake fans stop, temporary stops during taxi, brake on, throttle takeoff setting and other aircraft operational data.

Further, the landing or takeoff condition data 206E may include, for example, weather conditions, runway conditions and so on. In addition, the ATC condition data 206B may include, for example, available slots, allocated gates and so on. Also, the ground station data 206C may include, for example, available ground handling units type of ground handling units for performing scheduled turnaround activities, number of ground handling units, and so on. Moreover, the passenger information 206D may include, for example, number of passengers, baggage weight, information of special need persons (e.g., physically impaired persons), and so on.

Further, the actual start and end time stamps may be obtained by the analytics module 112 from the on-board system 104 and ground station system 202, in one embodiment. The analytics module 112 may then analyze the obtained actual start and end time stamps to determine time deviation of each scheduled turnaround activities. In one embodiment, the analytics module 112 may simultaneously analyze the obtained start and end time stamps of more than one activity to determine deviation from the scheduled turnaround activities. In one example, the time deviation may be determined by comparing the actual start and end time stamps with scheduled start and end time stamps of each scheduled turnaround activities.

Furthermore, after analyzing the obtained actual start and end time stamps, the data related to time deviation and the scheduled turnaround activities may be sent to the one or more interfaces 226A and 226B associated with the on-board computing system 104 and ground station system 202. The one or more interfaces 226A and 226B may present the time deviation along with the scheduled turnaround activities, upon receiving the data related to time deviation and the scheduled turnaround activities. In one embodiment, the analytics module 112 may include a performance management module 222. The performance management module 222 may provide a summary view of the time deviation and the scheduled turnaround activities on the one or more interfaces 226A and 226B. In one example, the summary view may include Gantt chart. The summary view allows monitoring of various scheduled turnaround activities at one glance. The summary view may be stored for statistical analysis. The statistical analysis may be performed by presenting statistical result as graphs which may be used for performance benchmarking of ground handlers and scheduled turnaround activity optimization.

For example, statistical analysis can be done on aircraft activities and parameters related to turnaround. Example statistical analysis may include taxi-in times by airport and by time of day/year, taxi-out times by airport and by time of day/year, activity starting delay analysis, activity duration and delay analysis, external factors and delay analysis (e.g., ATC clearance for pushback), idle time and buffer analysis, critical path analysis, departure delay analysis, APU running time analysis, water uplift analysis, brake cooling times. GPU connection versus block-on and block-off times, flight times for each aircraft type, ground air conditioning unit connection analysis, engine start and stop (vis a vis APU start/stop times), latitude/longitude at landing for taxi-in times and runway direction, patterns in water usage, predict water uplift quantity based on outgoing flight duration, number of passengers and so on.

In one embodiment, the analytics module 112 may include a delay prediction module 216. The delay prediction module 216 may determine an aircraft departure delay. The aircraft departure delay may be understood as delay in scheduled departure time of the aircraft. The aircraft departure delay may be caused by one or more scheduled turnaround activities. Further, the delay prediction module 216 may determine the aircraft departure delay by analyzing the time deviation of the scheduled turnaround activities. The aircraft departure delay predicted by the delay prediction module 216 may be presented on the one or more user interfaces 226A and 226B for notifying the users of the one or more interfaces 226A and 226B about the aircraft departure delay, so that the user can take an appropriate action for minimizing the aircraft departure delay. For example, the users may perform certain scheduled turnaround activities in parallel for minimizing the aircraft departure delay.

In one example, the presented time deviation and associated scheduled turnaround activities and/or alerts and associated aircraft operational parameters may be utilized by users of the one or more interfaces 226A and 226B for deciding on the improvement in time taken by a scheduled turnaround activity responsible for providing a delay in overall turnaround time from touchdown to takeoff of the aircraft. For example, an airline enterprise system may use the time deviation of the scheduled turnaround activities to determine taxi-in performance of the aircraft in the airport.

Further, the analytics module 112 may include a target off block time (TOBT) calculator 218 and a TOBT tracking module 220. The TOBT calculator 218 may estimate a TOBT for the aircraft based on estimated time of arrival (ETA) of the aircraft. In one example, the ETA may be estimated by the airport personals. Further, the TOBT tracking module 220 may dynamically revise the estimated TOBT for the aircraft based on the actual time of arrival of the aircraft and the progress of the optimized aircraft turnaround schedule after arrival of the aircraft. For example, if the ETA of the aircraft deviates or if a delay is predicted in the scheduled turnaround activities, then the ETA is revised based on the deviation or delay.

In one embodiment, the analytics module 12 may include an alert generation module 212. The alert generation module 212 may generate an alert if there is time deviation of the scheduled turnaround activities. For example, an alert may be generated when the predicted brake cooling times exceeds turnaround time. The alert may indicate, for example, aircraft late arrival, delayed and not started activities, started but late running activities, late finishing of scheduled turnaround activities, overlapping of dependent scheduled turnaround activities, delay prediction, aircraft ready for departure, and late aircraft departure. In one embodiment, the analytics module 112 may further include a workflow module 214. The workflow module 214 may help in flow of all the information/data 206 and 208 within the system 100 or 200.

Computing system 102 may include computer-readable storage medium comprising (e.g., encoded with) instructions executable by a processor to implement functionalities described herein in relation to FIGS. 1-2. In some examples, the functionalities described herein, in relation to instructions to implement functions of analytics module 112 and any additional instructions described herein in relation to the storage medium, may be implemented as engines or modules comprising any combination of hardware and programming to implement the functionalities of the modules or engines described herein. The functions of analytics module 112 may also be implemented by the processor. In examples described herein, the processor may include, for example, one processor or multiple processors included in a single device or distributed across multiple devices.

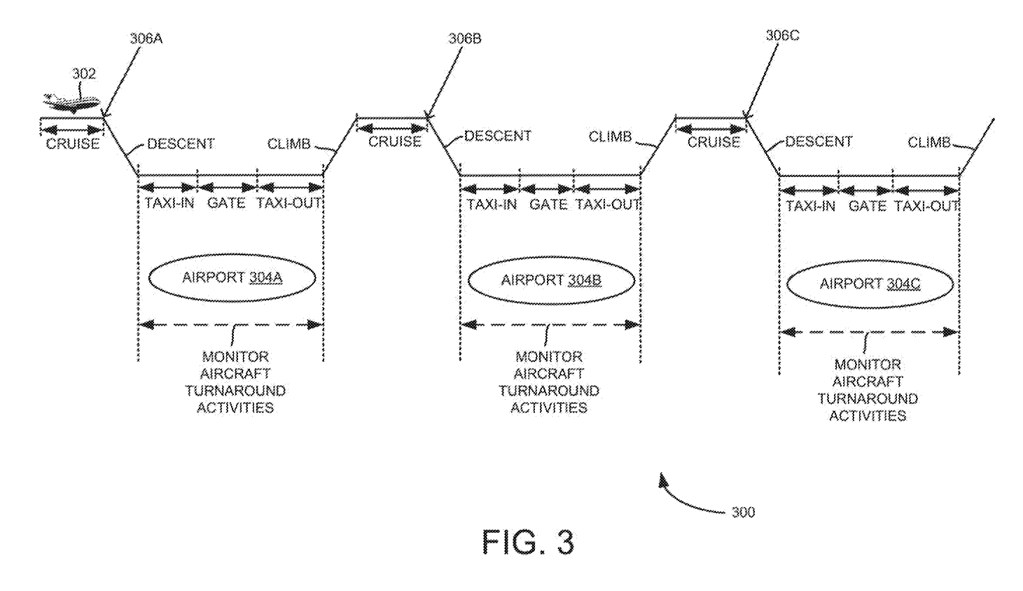

Referring now to FIG. 3, which illustrates an example timing diagram 300 showing various stages during journey of an aircraft 302. The example timing diagram 300 shows the journey of the aircraft 302 through airports 304A to 304C. For example, the various stages during journey of the aircraft 302 may be cruise, descent, taxi-in, at gate, taxi-out and climb stage of the aircraft at the each of the airports 304A- 304C. Furthermore, 306A-306C may indicate locations in the journey of the aircraft 302 when the aircraft on-board system sends data associated with turnaround activity related to the aircraft 302 to one or more ground handling units associated with the airports 304A-304C, respectively.

In one embodiment, prior to landing of the aircraft 302, at location 306A, the aircraft 302 sends the data associated with turnaround activity related to the aircraft 302 to one or more ground handling units in the airport 304A. For example, the data associated with turnaround activity related to the aircraft 302 may be sent 30 minutes prior to landing of the aircraft 302. The ground handling units may then modify scheduled start and end time stamps for the turnaround activities based on the received data. In one example, the ground handling units may modify the scheduled start and end time stamps for the turnaround activities using the configuration module 224. In addition, the configuration module 224 may be used to configure the turnaround activities by modifying templates for the turnaround activities, a list of the turnaround activities, scheduled start and end time stamps for the scheduled turnaround activities, interdependence between the scheduled turnaround activities, and source of obtaining start and/or end time stamps associated with each scheduled turnaround activity.

After arrival of the aircraft 302 in the airport 304A, the aircraft on-board system 104 may monitor the start and end time stamps for each turnaround activity. The start and end time stamps may be sent to the analytics module 112 for determining the time deviation from the scheduled turnaround activities. Subsequently, the time deviation and the data related to the turnaround activity are sent to one or more user interfaces 226A and 226B. The one or more user interfaces 226A and 226B may present the time deviation along with the data related to the turnaround activities. The presentation of time deviation along with the data related to the turnaround activities helps one or more users to reschedule the various turnaround activities, such as rescheduling of takeoff time of the aircraft 302. Similarly, at the airports 3048 and 304C, the aircraft on-board system 104 may monitor the start and end time stamps for each scheduled turnaround activity.

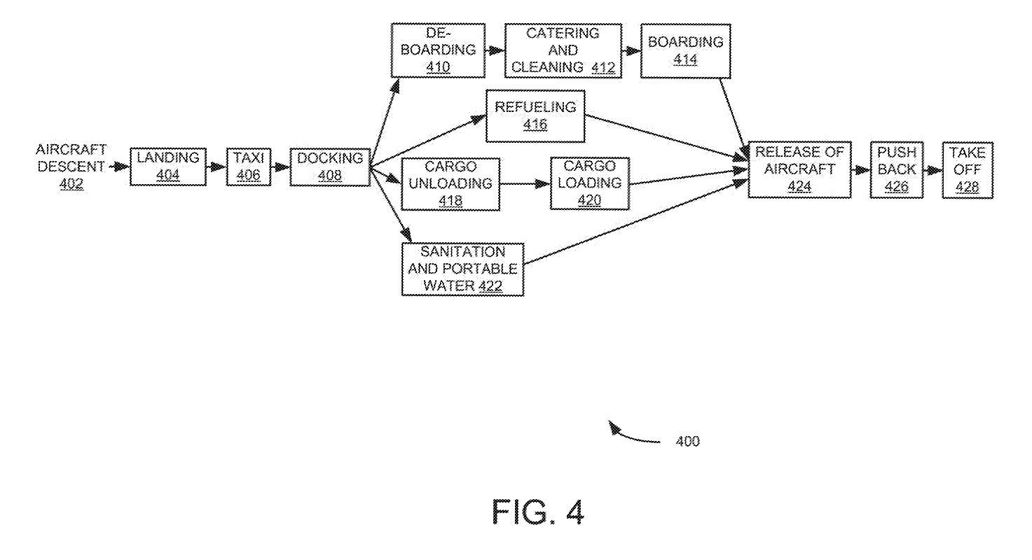

Referring now to FIG. 4, which illustrates an exemplary block diagram showing a sequence of scheduled turnaround activities from touchdown to takeoff of the aircraft, according to one embodiment. The scheduled turnaround activities include an aircraft descent 402, landing 404, taxi 406, docking 408, de-boarding 410, catering and cleaning 412, boarding 414, refueling 416, cargo unloading 418, cargo loading 420, sanitation and portable water 422, release of aircraft 424, push back 426, and takeoff 428.

The scheduled turnaround activities, such as landing 404, taxi 406 and docking 408 are scheduled to be performed one after another respectively, after the aircraft descent 402. Further, the turnaround activities, such as de-boarding 410, cargo unloading 418, and sanitation/toilet servicing and portable water 422 are scheduled to be performed in parallel. For example, the de-boarding 410, the cargo unloading 418, and the sanitation/toilet servicing and portable water 422 are performed by different ground handling units and hence may be performed in parallel. Furthermore, the refueling 416 is performed after the de-boarding 410 is completed. In addition, the turnaround activities, such as catering and cleaning 412, and boarding 414 are scheduled to be performed one after another, after de-boarding 410. Also, cargo loading 420 is scheduled after cargo unloading 418. Moreover, after the completion of the scheduled turnaround activities, such as boarding 414, refueling 416, cargo loading 420 and sanitation and portable water 422, the release of the aircraft 424 is scheduled to be performed. Also, after the release of the aircraft 424, the push back 426 and take off 428 are scheduled to be performed. Similarly, all other scheduled turnaround activities are scheduled based on the time taken for each scheduled turnaround activity, ground handling units used for performing the scheduled turnaround activities and availability of ground handling units to perform the scheduled turnaround activities.

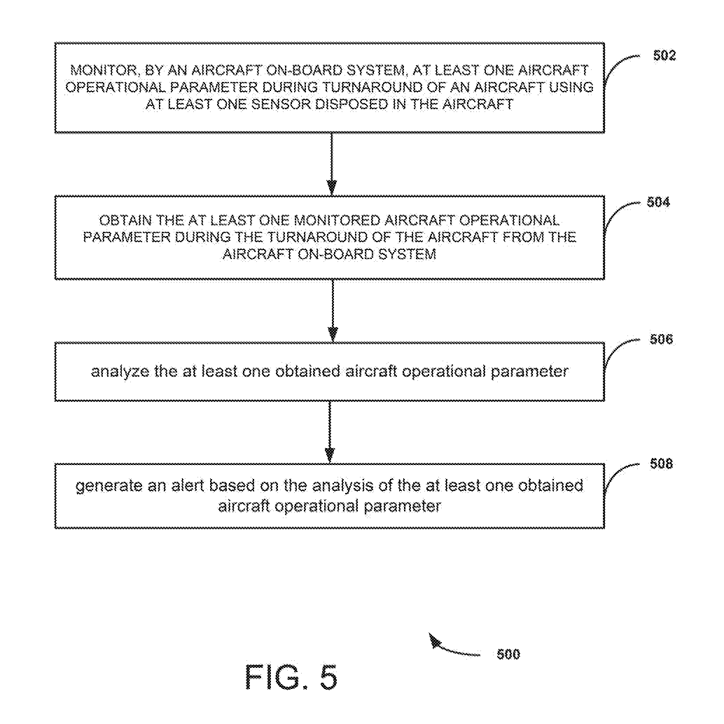

FIG. 5 illustrates an example flow chart 500 of a method for generating alerts based on an analysis of the monitored aircraft operational parameters. It should be understood that the process depicted in FIG. 5 represents generalized illustrations, and that other processes may be added or existing processes may be removed, modified, or rearranged without departing from the scope and spirit of the present application. In addition, it should be understood that the processes may represent instructions stored on a computer-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but rather the flow charts illustrate functional information to design/fabricate circuits, generate machine-readable instructions, or use a combination of hardware and machine-readable instructions to perform the illustrated processes.

At 502, at least one aircraft operational parameter may be monitored, by an aircraft on-board system, during turnaround of an aircraft using at least one sensor disposed in the aircraft. Example aircraft operational parameter may include cabin temperature, cargo temperature, flight deck temperature, wheel temperature, wheel pressure, fuel temperature, auxiliary power unit (APU) start and stop, APU bleed valve open and close, ground power unit (GPU) connection and disconnection, air conditioning unit connection and disconnection, cabin ready, evacuation slides status, landing runway, global positioning system (GPS) position, flight details, navigation database expiry and cycle, water quantity requested, water quantity filled, refueling quantity requested and refueling quantity filled, doors open and close, and/or ground service panels open and close. Example sensor may include, but not limited to, a video camera, an audio sensor and a temperature sensor.

At 504, the at least one monitored aircraft operational parameter is obtained during the turnaround of the aircraft from the aircraft on-board system. The at least one monitored aircraft operational parameter is obtained by an analytics module residing in a computing system that is on-board an aircraft or off-board an aircraft. In one example, the aircraft on-board system may receive the at least one aircraft operational parameter from at least one sensor disposed in the aircraft, and send the at least one aircraft operational parameter to the analytics module residing in the computing system via a wired or wireless network.

At 506, the at least one obtained aircraft operational parameter is analyzed, for instance, by the computing system that is on-board of the aircraft or off-board of the aircraft. At 508, an alert may be generated based on the analysis of the at least one obtained aircraft operational parameter. In one example, the alert may be generated when the at least one aircraft operational parameter related to the turnaround is above or below the threshold value or the range of threshold values. In another example, the at least one aircraft operational parameter and the generated alert may be displayed on a user interface associated with on-board or off-board computing systems to alert users of the user interface so that the users can take an appropriate action for minimizing the aircraft departure delay.

The process 500 of FIG. 5 may show example process and it should be understood that other configurations can be employed to practice the techniques of the present application. For example, process 500 may communicate with a plurality of computing devices and the like.

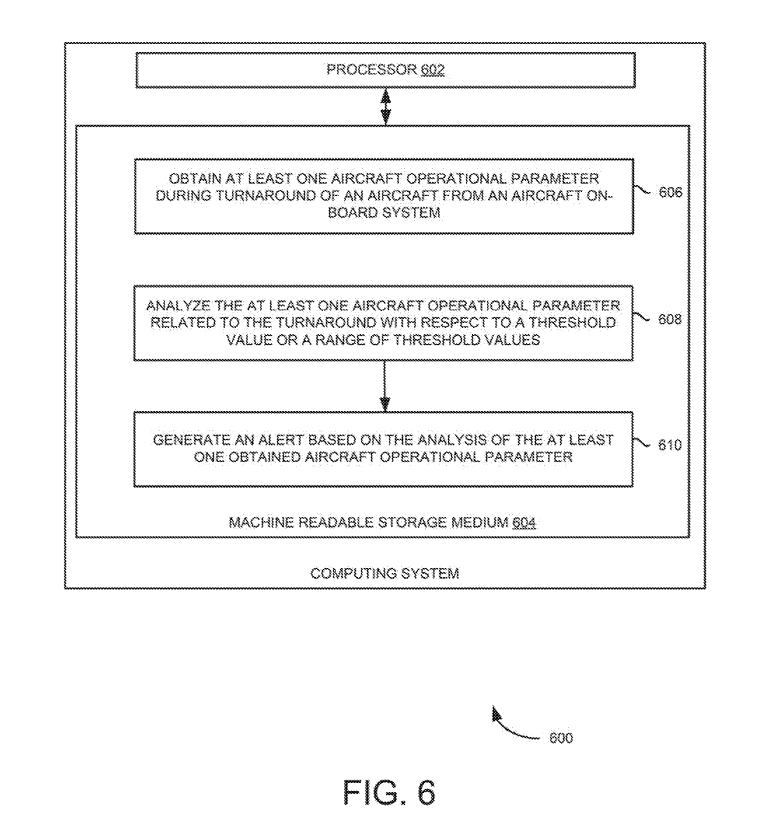

FIG. 6 illustrates a block diagram of an example computing device 600 to generate alerts based on an analysis of the monitored aircraft operational parameters. Computing device 600 may include processor 602 and a machine-readable storage medium/memory 604 communicatively coupled through a system bus. Processor 602 may be any type of central processing unit (CPU), microprocessor, or processing logic that interprets and executes machine-readable instructions stored in machine-readable storage medium 604. Machine-readable storage medium 604 may be a random access memory (RAM) or another type of dynamic storage device that may store information and machine-readable instructions that may be executed by processor 602. For example, machine-readable storage medium 604 may be synchronous DRAM (SDRAM), double data rate (DDR), rambus DRAM (RDRAM), rambus RAM, etc., or storage memory media such as a floppy disk, a hard disk, a CD-ROM, a DVD, a pen drive, and the like. In an example, machine-readable storage medium 604 may be a non-transitory machine-readable medium. In an example, machine-readable storage medium 604 may be remote but accessible to computing device 600.

Machine-readable storage medium 604 may store instructions 606-610. In an example, instructions 606-610 may be executed by processor 602 to generate alerts based on an analysis of the monitored aircraft operational parameters. Instructions 606 may be executed by processor 602 to obtain at least one aircraft operational parameter during turnaround of an aircraft from an aircraft on-board system. Instructions 608 may be executed by processor 602 to compare the at least one obtained aircraft operational parameter with a threshold value or a range of threshold values. Instructions 610 may be executed by processor 602 to generate an alert based on the comparison of the at least one obtained aircraft operational parameter with the threshold value or the range of threshold values.

It may be noted that the above-described examples of the present solution are for the purpose of illustration only. Although the solution has been described in conjunction with a specific example thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A computing system, comprising:
at least one processor; and
memory coupled to the at least one processor, the memory comprises an analytics module to:
obtain at least one aircraft operational parameter during turnaround of an aircraft from an aircraft on-board system;
analyze the at least one aircraft operational parameter related to the turnaround with respect to a threshold value or a range of threshold values; and
generate an alert based on the analysis of the at least one obtained aircraft operational parameter.

2. The computing system of claim 1, further comprising:
at least one user interface to present the at least one aircraft operational parameter and the generated alert.

3. The computing system of claim 1, wherein generating the alert based on the analysis comprises: generating the alert when the at least one aircraft operational parameter related to the turnaround is above or below the threshold value or the range of threshold values.

4. The computing system of claim 1, wherein the at least one aircraft operational parameter is selected from a group consisting of cabin temperature, cargo temperature, flight deck temperature, wheel temperature, wheel pressure, fuel temperature, auxiliary power unit (APU) start and stop, APU bleed valve open and close, ground power unit (GPU) connection and disconnection, air conditioning unit connection and disconnection, cabin ready, evacuation slides status, landing runway, global positioning system (GPS) position, flight details, navigation database expiry and cycle, water quantity requested, water quantity filled, refueling quantity requested and refueling quantity filled, doors open and close, and ground service panels open and close.

5. The computing system of claim 1, further comprising:
a configuration module to configure aircraft turn around activities to be performed to monitor the at least one aircraft operational parameter based on at least one of airline operations and airport conditions.

6. The computing system of claim 1, wherein the at least one aircraft operational parameter is obtained using at least one sensor installed in the aircraft.

7. The computing system of claim 1, wherein the at least one sensor is selected from a group consisting of a video camera, an audio sensor and a temperature sensor.

8. The computing system of claim 1, comprises one of an on-board computing system and a ground station system, wherein the ground station system comprises one of an airport computing system, a ground handling unit, an airline computing system.

9. The computing system of claim 1, wherein the aircraft on-board system is to receive the at least one aircraft operational parameter from at least one sensor disposed in the aircraft, and wherein the aircraft on-board system is to send the at least one aircraft operational parameter to the analytics module via a network.

10. A method comprising:
monitoring, by an aircraft on-board system, at least one aircraft operational parameter during turnaround of an aircraft using at least one sensor disposed in the aircraft;
obtaining the at least one monitored aircraft operational parameter during the turnaround of the aircraft from the aircraft on-board system;
analyzing the at least one obtained aircraft operational parameter; and
generating an alert based on the analysis of the at least one obtained aircraft operational parameter.

11. The method of claim 10, wherein generating the alert comprises:
generating the alert when the at least one aircraft operational parameter related to the turnaround is above or below a threshold value or a range of threshold values.

12. The method of claim 10, wherein the at least one aircraft operational parameter is selected from a group consisting of cabin temperature, cargo temperature, flight deck temperature, wheel temperature, wheel pressure, fuel temperature, auxiliary power unit (APU) start and stop, APU bleed valve open and close, ground power unit (GPU) connection and disconnection, air conditioning unit connection and disconnection, cabin ready, evacuation slides status, landing runway, global positioning system (GPS) position, flight details, navigation database expiry and cycle, water quantity requested, water quantity filled, refueling quantity requested and refueling quantity filled, doors open and close, and ground service panels open and close.

13. The method of claim 10, further comprises:
presenting the at least one aircraft operational parameter and the generated alert on at least one user interface.

14. The method of claim 10, wherein the at least one sensor is selected from a group consisting of a video camera, an audio sensor and a temperature sensor.

15. The method of claim 10, wherein obtaining the at least one monitored aircraft operational parameter during the turnaround of the aircraft from the aircraft on-board system comprises:
receiving, by the aircraft on-board system, the at least one aircraft operational parameter from at least one sensor disposed in the aircraft; and
obtaining the at least one aircraft operational parameter from the aircraft on-board system by an analytics module residing in a computing system via a wired or wireless network.

16. The method of claim 14, wherein the at least one obtained aircraft operational parameter is analyzed by the computing system that is on-board of the aircraft or off-board of the aircraft.

17. A non-transitory computer-readable medium having computer executable instructions stored thereon, which when executed by a processor causes the processor to:
obtain at least one aircraft operational parameter during turnaround of an aircraft from an aircraft on-board system;
analyze the at least one aircraft operational parameter related to the turnaround with respect to a threshold value or a range of threshold values; and
generate an alert based on the analysis of the at least one obtained aircraft operational parameter.

18. The non-transitory computer-readable medium of claim 17, wherein generating the alert comprises:
generating the alert when the at least one aircraft operational parameter related to the turnaround is above or below the threshold value or the range of threshold values.

19. The non-transitory computer-readable medium of claim 17, wherein the at least one aircraft operational parameter is selected from a group consisting of cabin temperature, cargo temperature, flight deck temperature, wheel temperature, wheel pressure, fuel temperature, auxiliary power unit (APU) start and stop, APU bleed valve open and close, ground power unit (GPU) connection and disconnection, air conditioning unit connection and disconnection, cabin ready, evacuation slides status, landing runway, global positioning system (GPS) position, flight details, navigation database expiry and cycle, water quantity requested, water quantity filled, refueling quantity requested and refueling quantity filled, doors open and close, and ground service panels open and close.

20. The non-transitory computer-readable medium of claim 17, further comprises:
presenting the at least one aircraft operational parameter and the generated alert on at least one user interface.

21. The non-transitory computer-readable medium of claim 17, wherein the at least one sensor is selected from a group consisting of a video camera, an audio sensor and a temperature sensor.
